(19) United States
(12) Patent Application Publication
(10) Pub. No.: US 2018/0065135 A1
(43) Pub. Date: Mar. 8, 2018

(54) SPRAY APPLICATING LINE AND ASSEMBLY FOR PRODUCING A COATED PART AND INCLUDING MULTIPLE OVERSPRAY AND RECAPTURE/RECYCLE CONFIGURATIONS

(71) Applicant: Oria Collapsibles, LLC, Auburn Hills, MI (US)

(72) Inventor: Miguel A. Linares, Bloomfield Hills, MI (US)

(21) Appl. No.: 15/680,624

(22) Filed: Aug. 18, 2017

Related U.S. Application Data
(60) Provisional application No. 62/383,962, filed on Sep. 6, 2016.

(51) Int. Cl. B05B 15/12

(52) U.S. Cl. CPC B05B 15/1225; B05B 15/1288

(57) ABSTRACT

An overspray spray capture structure integrated into a paint spray operation integrates at least one reception surface for receiving an overspray of the spray coating operation. The overspray is communicated through a merging location established between the receiving surfaces and adapted to being removed or recycled. The at least one reception surface further includes first and second oriented reception surfaces not limited to a pair of horizontal and vertical closed loop belt curtains which are traversable supported about a pair of spaced apart rotating shafts. The first and second reception surfaces can include traversing paper rolls for capturing the overspray therebetween at the merging location. Other variants include water curtain or vacuum removal assist assemblies for removing the overspray prior to it setting.

### CROSS REFERENCE TO RELATED APPLICATIONS

The present invention claims the priority of U.S. Ser. No. 62/383,962 filed Sep. 6, 2016.

### BACKGROUND OF THE INVENTION

### Field of the Invention

The present invention discloses a multi-station robotic spray applicating line and assembly. In particular, the invention optimizes a variety of configurations for recapturing any atomized plastic overspray resulting from coating of a part suspended in front of a spray booth station exhibiting a recessed configuration, the atomized overspray for efficient recycling or disposal.

### Discussion of the Background Art

The prior art documents examples of spray assemblies for coating parts in a progressive and high-volume fashion. An example of this is depicted in the process and assembly of US 2015/0283569 to Linares for a mass producing a plasticized coated and structurally supporting insert including a first conveyor for advancing a plurality of lay-flat inserts and at least one lift and transfer mechanism for transferring the inserts between the first conveyor and a second overhead conveyor. A dual function robot is positioned astride the first conveyor and has a first numerically controlled gripping portion for engaging and raising a selected one of the lay flat supported inserts. The robot further has a second numerically controlled and articulating arm for spray coating a plasticized material upon the insert.

Additional prior art assemblies and systems are also known for recovering or removing overspray of the plasticized coating material. Examples include the paint spraying booth of Kearney U.S. Pat. No. 4,283,999 which has a back wall over which a water curtain flows to collect sprayed paint, a tank to receive the water curtain, vertical entrainment ducts disposed above the rear part of the tank, means for generating a flow of air through said ducts to lift water from the tank for the formation of the water curtain, a vertically-disposed wall separating the front and rear parts of the tank and having one or more transfer openings below the water surface, and baffle plates ifs the front part of the tank causing paint-laden water from the curtain to flow to a remote zone before returning to the transfer opening in order to minimize the quantity of paint passing into the rear part of the tank. A surface-removal device, preferably with a venturi unit, is arranged in front of the transfer opening to remove floating paint and pass it back to the baffled region for further dispersal.

U.S. Pat. No. 3,811,371, to Hardy, teaches a paint spray booth including side and top walls, the top wall having a vent opening. A roll of curtain material is provided and consists of a layer of non-woven fabric and a scrim of woven material located outside and above the booth. A portion of the roll material extends downwardly to form one wall of the booth, with another portion of the material extending rearwardly and away from the first roll to a collapsible recovery shaft positioned outside of the paint spray area.

Tashiro U.S. Pat. No. 8,435,348 teaches a paint booth with purifier which includes a water tank, pump, water cord formation mechanism, sludge removal mechanism, exhaust mechanism, and barrier member. The water cord formation mechanism includes a water case located in an upper part of a spray chamber. A large number of nozzles are formed in a bottom wall of the water case. Each nozzle includes a tubular portion, the inside diameter of which is reduced downward from an inlet, and a circular outlet. Water falling in straight lines from the outlet forms a large number of parallel water cords. Paint mist is collected as air containing the paint mist contacts the water cords. An exhaust chamber is formed on the hack side of the barrier member.

Lehmann, Jr., U.S. Pat. No. 4,323,030, teaches a spray coating device with particulate material in a coating chamber. In connection with a change of coating material, e.g. a color change, it is desirable to remove the previous coating material from he coating chamber. To this end, the inner walls of the coating chamber are defined by movable endless belts whose inner courses move to deliver coating material that has accumulated thereon to the floor of the chamber. The floor of the chamber is also comprised of an endless belt that moves the coating material out of the chamber. The roof of the chamber is also comprised of an endless belt which moves the coating material to one of the side walls. The belts may be cleaned by various devices such as a. brush, gas blast nozzles and/or a suction device. Slots defined in the walls permit introduction of the article to be sprayed and the spraying device into the chamber. Plastic elements limit the size of the slot through which the spraying device passes.

Finally, U.S. Pat. No. 6,027,566 to Telchuk teaches a paint spray booth for painting an article and separating the spent paint overspray form the air and water used in the booth to collect the spent paint material is disclosed. The booth includes a water containing pan which has a deep portion and a shallow drain portion. The water used to separate the spent paint from the air and to clean the air discharged from the booth is collected on the drain portion and sent to the deep portion of the pan in a manner to cause a flow in the drain portion and deep portion of the pan to prevent accumulation of spent paint in undesired, inaccessible locations and to encourage movement of spent paint to desired, accessible locations in the pan and/or for removal or further treatment as by settling, skimming and/or separating, or the like, to provide the present invention with low maintenance similar to or less than other such booths, such as dry filter paint spray booths. The booth has a water manifold in its eliminator-washer section with a plurality of openings therein covered by a space “v” shaped cap which is easily cleaned and kept clean. The booth, preferably, has a spent paint intake pipe with a plurality of slots therein extending across and submerged below the surface of the tank to draw off the spent paint containing water, some of which is recirculated to the tank some of which is recirculated in the washer section of the booth, and some of which is sent to be concentrated and remove the spent paint material.

### SUMMARY OF THE PRESENT INVENTION

The present invention teaches a plasticized spray applicating apparatus for coating multiple suspended and progressively conveyor advance-able articles, such as without limitation including items of furniture, in combination with various capture configurations for removing (for disposal or recycling) paint overspray. As will be disclosed, this can include any of vacuum, traversable belt, and water curtain assisted booths positioned at the spray zone for assisting in removal of overspray.

A structure integrates at least one reception surface for receiving an overspray of the spray coating operation. The overspray is communicated through a merging location established between the receiving surfaces and adapted to being removed or recycled. At least one reception surface further includes first and second oriented reception surfaces. The reception surfaces further includes a pair of horizontal and vertical closed loop belt curtains which are traversable supported about a pair of spaced apart rotating shafts. The first and second reception surfaces can include traversing paper rolls for capturing the overspray therebetween at the merging location.

The closed loop belt curtains further include a passageway interior through which is communicated a chilling fluid for cooling the overspray reception surfaces. A pair of knife blades are positioned in contact with the reception surfaces. The closed loop belt curtains further includes pluralities of offset ribs extending within the passageway interior from opposing inner surfaces to facilitate event chilling fluid dispersal.

The reception surface further can include a waterfall curtain, with a collection reservoir located beneath the curtain. A water pump and filtration system is integrated into the structure pumping a steady fluid flow to a supply manifold located above the waterfall curtain.

Other features include first and second blowers arrayed at respective forward and upper edges thereof of the first and second reception surfaces, an air curtain created by the blowers in a direction towards the overspray merging location. A bottom end collection location is integrated within the structure for removing solid particulates from the collected overspray. A plurality of centrifugal force inducing tubes are integrated into the structure for converting the blower induced air curtain into a cyclonic vacuum through the merging location.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of a spray applicating line according to one non-limiting embodiment and which includes a plurality of several rotary positioned individual spray booth stations in networked contact with an overhead feed carousel, the carousel communicating with both an inlet conveyor for supplying inserts to be coated and an outlet conveyor for delivering finished coated parts;

FIG. 2 is an enlarged sectional of a pair of successively located spray booth stations and in which the first station is plasticized coating a wire harness and the second station is coating a pallet article;

FIG. 3 is a further enlarged view of a selected spray booth station depicting a first variant of overspray recapture in the form of a pair of converting conveyors, each further exhibiting a liquid nitrogen curtain providing a cold capture surface for the overspray and preventing premature curing and drying before collection thereof;

FIG. 4 is a succeeding rear rotated perspective view of the spray booth station of FIG. 3, with part of the housing removed and first illustrating the direction retrieval of the collected overspray in combination with the scraping knife edges and vacuum assist;

FIG. 5A is a further enlarged side plan view of the converging conveyors of FIGS. 3-4 and illustrating the construction of the liquid nitrogen bags which provide the chilled surfaces for supporting the overspray material during without the same curing during delivery to the rear drop off/recycle area located behind the horizontal and vertical oriented conveyors;

FIG. 5B is a partial cutaway of a selected conveyor and exhibiting an interior offset rib pattern established between opposing inner width defining surfaces of the belt, such assisting in maintaining internal spatial separation to ensure equal distribution of the cooling nitrogen to prevent exterior surface curing of the captured overspray material;

FIG. 6 is a perspective of an alternate variant in which a vertically disposed water cascade curtain is positioned rearwardly of the suspended/spray coated part, the curtain working in combination with a bottom fluid reservoir for capturing the overspray and associated solid particles for subsequent filtering for disposal or recycling;

FIG. 7 is a rotated rear perspective of FIG. 6 in partial cutaway and showing the pump and fluid delivery architecture integrated into the vertical water curtain operating in combination with vacuuming of residual airborne particles;

FIG. 8 is a perspective of a further alternate variant, similar in regards to that shown in FIGS. 3-5, and in which a pair of vertical and horizontal belt driven curtains operate in combination with a pair of elongated blowers positioned at both forward most and upper edge most locations of the curtains to assist in capture and evacuation of overspray and associated particles resulting from the spray coating process;

FIG. 9 is a rotated and rear perspective of FIG. 8 in partial cutaway and showing the blower support construction including architecture for promoting cyclonic action with centrifugally induced separation of airborne particles associated with the captured overspray;

FIG. 10 is a perspective view of a yet further variant of the present inventions, and which combines a pair of horizontal and vertically oriented advancing heavy duty paper curtains which are built into the recess housing of the station for capturing the overspray and particles; and

FIG. 11 is a rotated and rear perspective of FIG. 10 in partial cutaway and depicting pairs of feed and take up rolls associated with each of the horizontal and vertical oriented paper curtains, a vacuum zone again being configured at a width extending and joining space established between converging ends of the curtains to further assist in overspray and particle removal.

### DETAILED DESCRIPTION OF THE PREFERRED EMBODIMENTS

As previously described, the present invention discloses a multi-station robotic spray applicating line and assembly. With particular reference to the attached and below described illustrations, the invention optimizes a variety of configurations of overspray retrieval station booths, these operating in combination with an overhead conveyor and numerically controlled spray applicating robot for recapturing any atomized plastic overspray and associated particulates, including vapors, resulting from the spray robot coating a part suspended in front of the spray booth station.

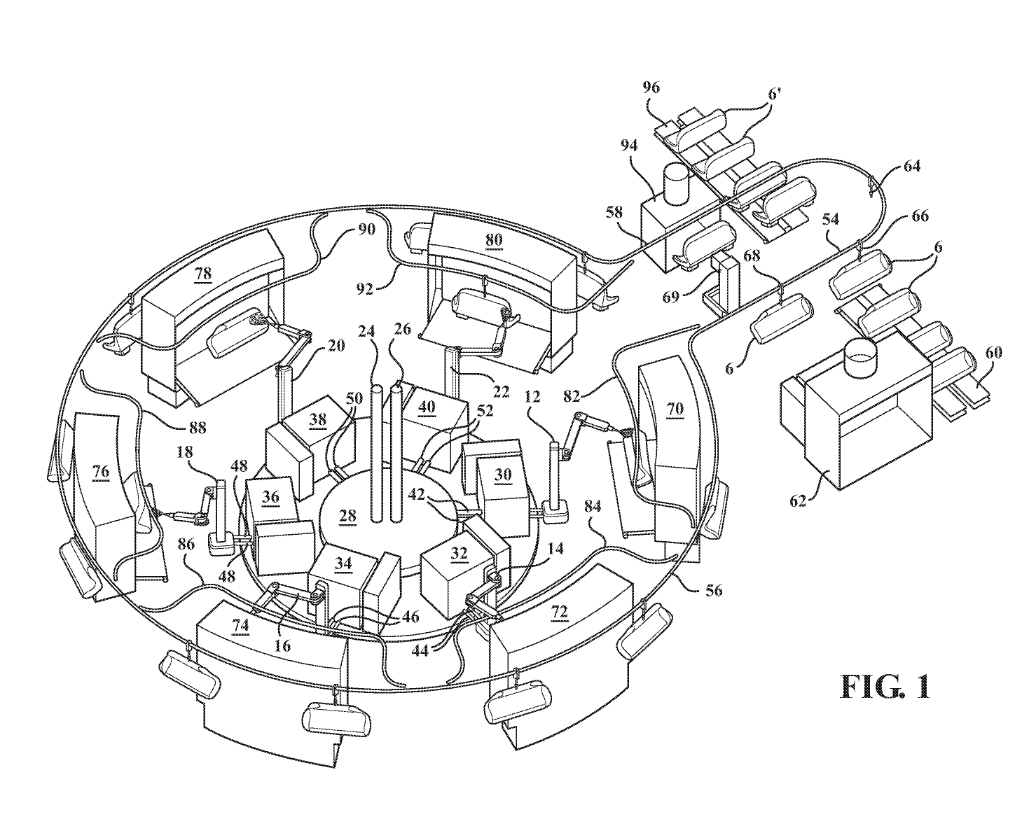

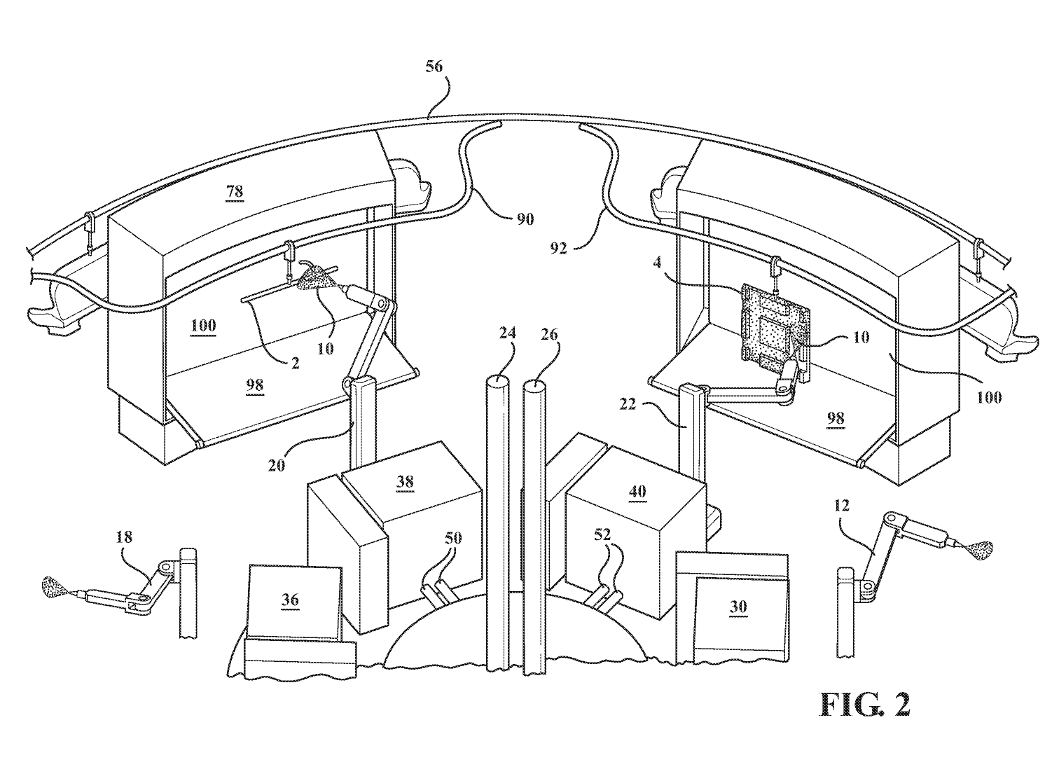

As is known, the spray coating of irregular shaped parts, examples of which include a wire harness 2 and a pallet 4 (see FIG. 2), as well as any other article, such as further depicted at 6 in FIG. 1 and which can represent one non-limiting example of any type of furniture article, and with respect to which a percentage of a plasticized fluidic overspray (see atomized pattern 10 in FIGS. 2 et seq.) inevitably results in the carrying out of the spray applicating program associated with the numerically controlled robot assembly. One depicted and non-limiting arrangement illustrates a plurality of six such robots at 12, 14, 16, 18, 20 and 22 arranged in an outwardly perimeter facing fashion, these being supplied with a plasticized fluid typically provided in separate conduit fed quantities including main iso 24 and poly 26 in-feed lines.

Without limitation, the iso/poly mixture can also include any singular or multiple feed lines of material including any of a polyuria, polyurethane or other plasticized mixture, such further including any particulate/aggregate, any catalyst or other additive for providing desired properties to the coated article. The present invention further contemplates the ability to spray apply any known plasticized compositions as well as proprietary blends which provide desirable features in use with given inserts/parts, such as which can again include any type of furniture or other article of a suitable shape and size which can be traversed upon the suspended carousal (or otherwise supported) and which can be coated in any fashion envisioned which is consistent with the present description.

As further shown in FIG. 1, the main iso/poly 24/26 infeed lines are redirected from a central infeed hub 28 in branched fashion to each of a plurality of distribution sub-stations 30, 32, 34, 36, 38 and 40 dedicated, respectively, to each of the spray robots 12, 14, 16, 18, 20 and 22. To this end, respective pairs of iso/poly branch lines are extend from the central hub 28 to each of the delivery sub-stations 30-40 and are further referenced respectively at 42, 44, 46, 48, 50 and 52. A pressurized air/pneumatic fluid infeed can also be distributed to each of the spray robots to assisting in atomizing the iso/poly components, such as which are depicted as being separately fed into a base of each robot and which can admixed prior to issuance through the associated spray application head.

Without further elaboration, the individual spray robots 12-22 are of a known construction and include multi-articulating and/or rotating axes of motion which, in combination with a remote programmable processor/numerical controller (not shown) operates a spray applicating head associated with each NC robot in order to distribute the iso/poly spray mixture (see again at 10) upon the surface of a given part (see again at 2, 4, 6, et seq.). Advancing of the parts is further accomplished, in one non-limiting example depicted in the illustrated variant, by an overhead carousal which is constructed of a closed loop support hanger.

Further depicted in FIG. 1 is the overhead hanger including each of an in-feed station 54 in which the selected inserts 6 are acquired, a succeeding circular extending main portion 56 in which the inserts are distributed to each of the individual substations, and an outfeed location 58 in which the coated inserts are removed. Although not shown, the conveyor can be secured by overhead hangers to a ceiling of an associated enclosure and it is further understood that a suitable chain drive or other advancing mechanism can be built into the conveyor in order to advance the same in closed loop fashion.

Additional features include a first infeed conveyor 60 upon which are conveyed the uncoated parts 6 (or blanks). A checking or repair station 62 is depicted at the inlet location and at which the precoated inserts or blanks can be inspected and any blemishes repaired prior to the overhead conveyor distributing the same to the several sub-stations.

A plurality of hooks 64, 66, 68, et seq., are depicted extending downwardly from the main overhead conveyor and, in combination with a suitable lift or acquiring mechanism. This is further depicted by a lift on/lift off robot 69 which is positioned in proximity to each of the inlet 54 and outlet 58 locations and which is further rotatable to sequentially place uncoated inserts from the inlet conveyor 60 onto the overhead carousal at a first location and to remove completed spray coated inserts at the outlet 58 for placement upon an outlet conveyor (see as further described below at 96).

In this fashion, the robot 69 operates initially to elevate or position the individual inserts 6 so that they are suspended in successively fed fashion upon the hooks in the manner shown. The conveyor is further understood to integrate any suitable belt or chain feed (not shown), such operating to advance each succeeding in-fed insert 6 to a spray coat substation (this further defined by a spray robot and opposing positioned and corresponding overspray capture booths 70, 72, 74, 76, 78 and 80).

As further shown in FIG. 1, localized branching locations are depicted at 82, 84, 86, 88, 90 and 92, corresponding to overspray capture booths 70-80 respectively. The branching locations 82-92 are arranged in circumferentially spaced fashion about the main circular loop defined by the conveyor 56 between the inlet 54 and outlet 58 ends and, as further shown, each includes both exit and reentry locations at opposite ends, this in order to receive an uncoated insert from the main carousal 56, position the same in elevated fashion between the forward facing booth and the associated spray robot for coating, and then subsequently redirect the coated insert to merge back onto the outer carousal for 56 for completed traversing about the outer perimeter carousal 56 for subsequent delivery to the outlet 58.

The chain drive integrated into the overhead carousal is further configured in order to extend throughout the main conveyor 56 and the associated branching sections 82-92, with the understanding that an associated controller can be provided for directing the inserts to each station, such as in combination with directional switching tracks integrated into the inlet end of each branch and so that, upon a selected uncoated insert being delivered from the main conveyor 56, the inlet is switch to permit successive inserts to traverse past and for delivery to the downstream located stations.

Upon completion of a coating operation at any of the branching stations, the coated insert is thence shuttled back onto the main conveyor 56 for traversing around and past the succeeding located stations (again via the track at each branching inlet being switched to the desired position). Upon the coated inserts reaching the outlet location 58 of the carousal, a secondary operation station is located for likewise inspecting/remedying any issues with the now coated inserts (see at 6′). Such outlet end secondary operations can also include applying any desired labeling, stamping or branding to the completed parts, following which these are in succession removed from the overhead conveyor at the outlet and deposited upon the removal conveyor 96.

Beyond the examples of inserts or articles, 2, 4, 6 et seq., illustrated, it is further understood that any other insert or article can be provided to be spray coated, such including any of an encapsulating wood, bamboo, composite, metal, foam, furniture, pallet or other article, and such as further which can be applied to any of a cardboard material, including a rigid paperboard and/or honeycomb construction. As further previously described, any type of insert or part can be spray coated, not limited to the pallet, wire harness or furniture examples depicted herein. To this end, the associated programming of a given software code or command sequence for directing the motion and angle of application of the spray applicating head of each articulating robot assembly, such also envisioned the ability to adjust the pattern of spray (wide versus narrow) and in the attempt to maximize the percentage of spray being applied to the unique configuration of the part or insert

The above stated, it is further understood that, all efforts to the contrary, a (typically small) percentage of the applied spray will inevitably result as an overspray which misses the part and which will need to captured and removed. This percentage of overspray can often range from 1-2% upwards, depending upon the complexity of the part being coated, in response to which the present invention illustrates a series of overspray capture station booth configurations (such as again initially provided at 70-80 in the initial variant of FIGS. 1-5, and which seeks to isolate, capture, remove and recycle each of the atomized overspray, any associated particulate administered in the spray, as well any associated fumes or vapors resulting from the plastic spray which is desirable to also remove.

The overspray capture booths each, as shown, exhibit a three dimensional body within which is configured a recessed forward facing surface volume (this opposing the articulating robot spray nozzle with the insert positioned therebetween). A pair of widened and closed loop conveyor belts are integrated into each of the overspray booths and include a first lower horizontal positioned belt 98 and a second rear end and vertically extending belt 100 (see as further shown in FIG. 2).

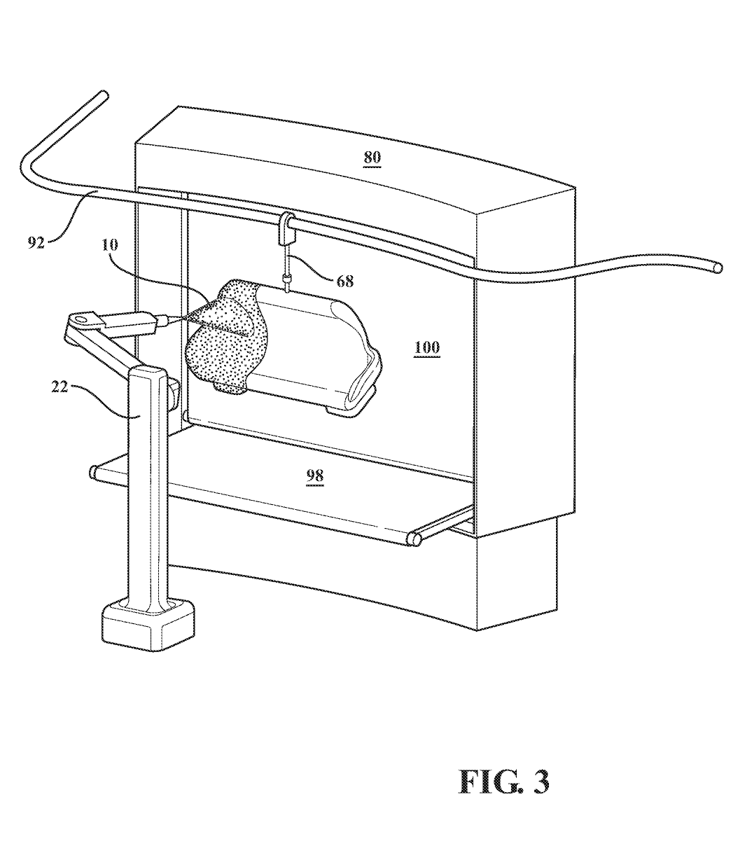

As further shown in successive FIG. 3, a further enlarged view of a selected spray booth station 80 depicts a first variant of overspray recapture in the form of the pair 98/100 of horizontal and vertical converting conveyors, these being provided in combination with a vacuum blower assembly 102 for further assisting in drawing in and subsequent filtration of any of overspray, particles and/or vapors resulting from coating of the part (see further arrows 104, 106 and 108). The arrangement of the belts 98/100 is again such that they collectively establish an interconnecting rear and bottom of the recess interior defined in the overspray station superstructure 80.

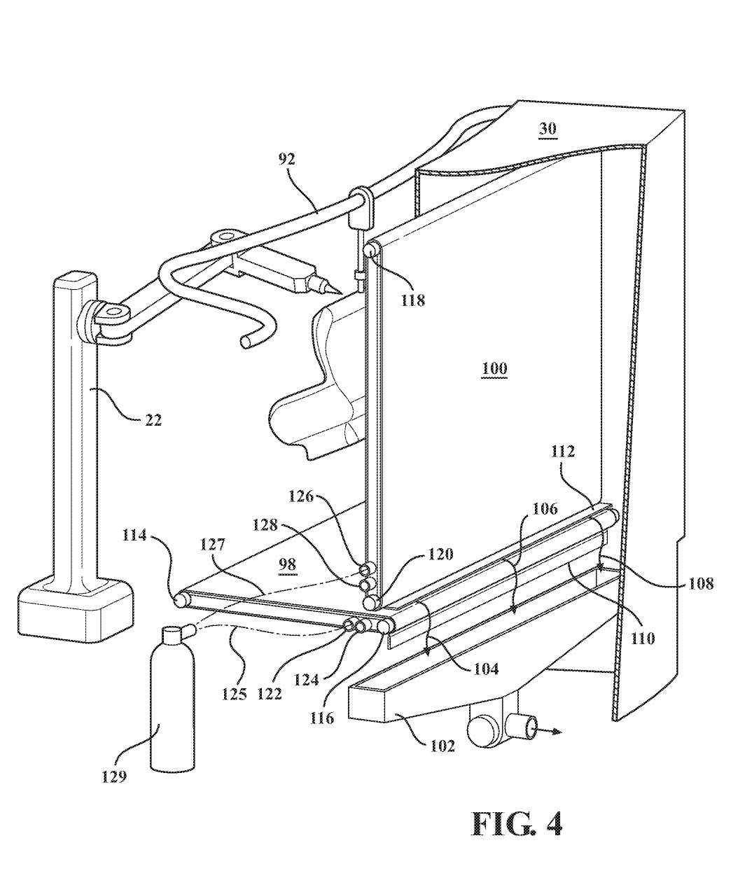

FIG. 4 is a succeeding rear rotated perspective view of the spray booth station 80 of FIG. 3, with part of the housing removed to better illustrate the direction of retrieval of the collected overspray in combination with a pair of scraping knife edges. These are depicted by vertical extending knife edge 110 arranged in width extending fashion underneath and in scraping edge location relative to a return underside location of the horizontal conveyor 98, a horizontal extending knife edge 112 further arranged in a combined rear bottom edge and width extending fashion relative to the vertical conveyor 100.

Each of the closed loop conveyors 98/100 further includes a pair of opposite end supported rollers, see at 114/116 for conveyor 98 and further at 118/120 for conveyor 100. A closed loop open interior of the conveyor supported belts is further configured to be accessed by inlet and outlet fluid ports (see in/out ports 122/124 for belt 98 and further in/out ports 126/128 for belt 100).

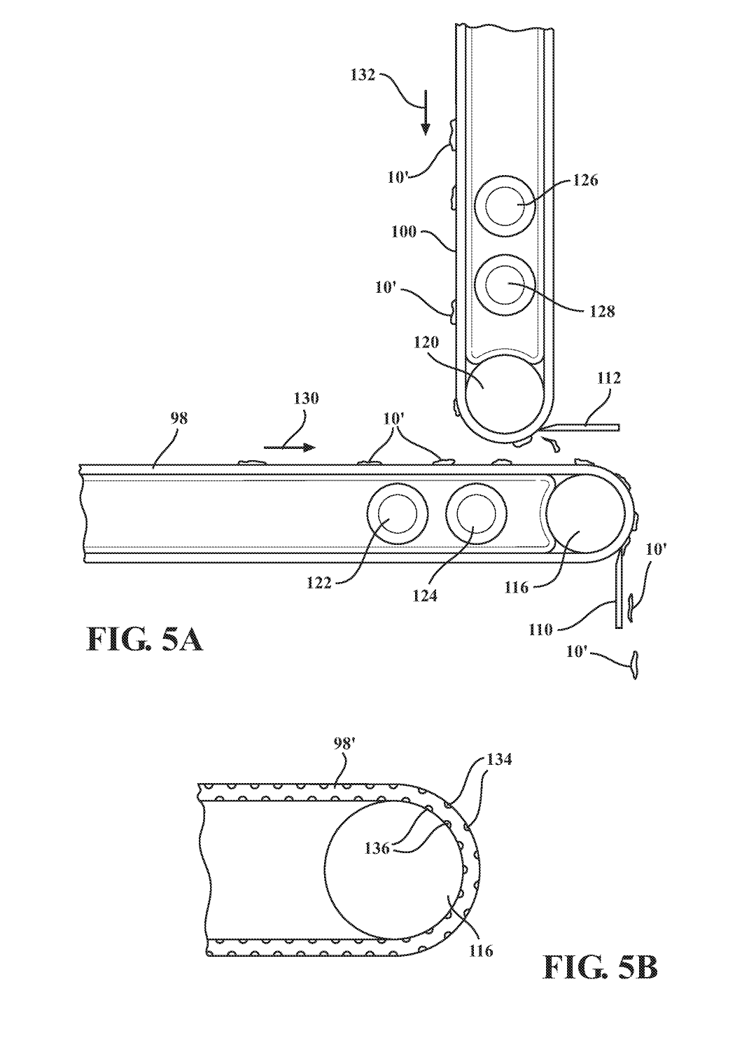

Conduits (see at 125 and 127) extend to/from the ports and which circulate, on an inlet side, a gas such as a liquid nitrogen (see tank at 129 designated as LN₂) for chilling the belts, such as in order to provide the exterior surfaces of the belts with a cold capture surface and in order to prevent drying or curing of overspray splatter 10′ adhering to the surfaces of the belts 98/100 as there are driven/conveyed rearwardly. This is further represented by horizontal arrow 130 in FIG. 5 (belt 98) and downwardly directed arrow 132 (belt 100) with the collected splatter 10′ coming into contact with the scraping edge positioned knife blades 110/112, resulting in peeling off the overspray for collection in combination with the vacuum blower retrieval of associated particles and vapors.

Although not shown, the overspray and associated particles 10′ drop off the rear interior of the housing at the merging location of the belts 98/100 and are collected in a separate bin or conveyed to a further recycling area. In combination, the vacuum blower 102 may additionally withdraw associated vapors, microscopic sized particles and the like for filtering and venting.

Additional conduits are connected to selected outlet ports 124 and 128 of the belts and, in combination with the inlet ports 122 and 126, provide for continuous circulation of the desired chilling fluid to prevent premature curing of the overspray splatter upon the surface of the collecting/conveying belts 98/100. The present invention further contemplates the use of any other environmentally conditioning fluid or application to the belt surfaces, such including heating, cooling or modulating other physical characteristics thereof in order to retard the drying and curing of the overspray 10′ until collected and removed in the manner described.

FIG. 5A is a partial cutaway of a selected conveyor belt 98′ and exhibiting an interior offset rib pattern established between opposing inner width defining surfaces of the belt (see first plurality of ribs 134 facing inwardly and which are opposed by a second axial offset and outwardly facing plurality of ribs 136). Given the tendency of the conveyor rollers 114/116 and 118/120 to pinch the open interior belts at the reversing ends of each belt 98/100, such a ribbing or separating construction integrated into the width and length extending interior surfaces of the belts assists in maintaining an adequate measure of internal spatial separation (i.e. preventing collapsing of the belt interior as they travel around the rollers), this to ensure equal distribution of the cooling nitrogen (or other suitable fluid) and to prevent exterior surface curing of the captured overspray material 10′.

The construction of the continuous and closed loop belts 98/100 can include any of a rubber, plastic, metal or any flexible composite. The scraping edge positioned knife edge blades 110 and 112 can further be supported within the station booth interiors in such a fashion that they may be tensioned or biased into an adequate surface contact with their respective belts, such occurring without damaging the belts or prematurely wearing down of the sharpened blade edges.

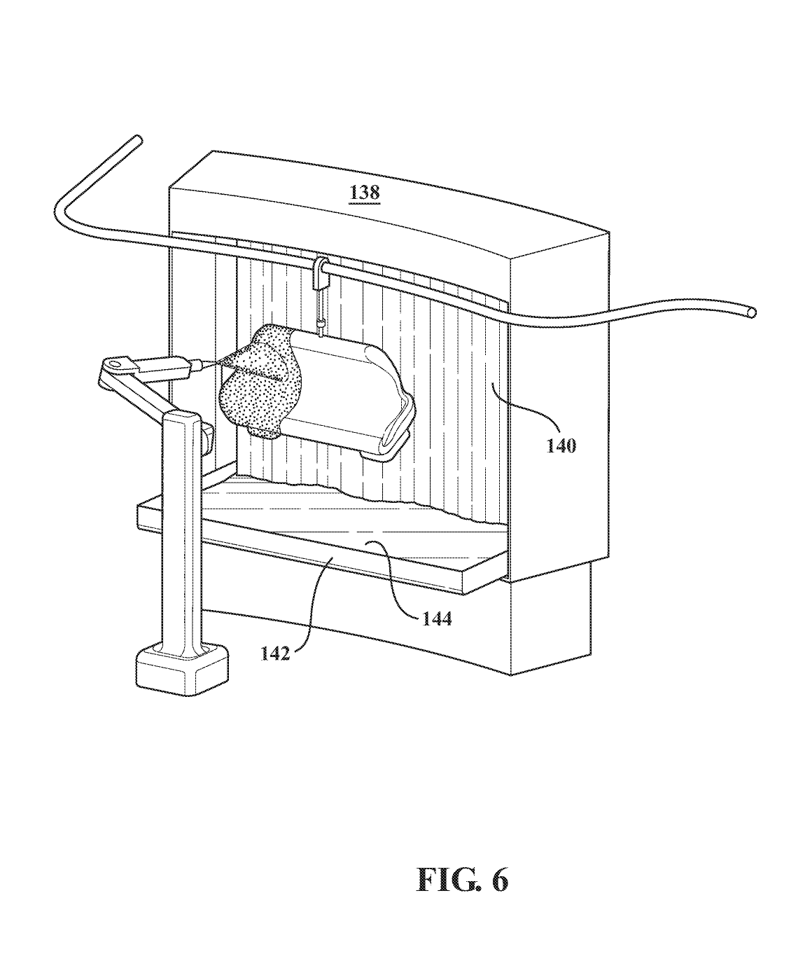

Proceeding to FIG. 6, a perspective is illustrated at 138 of an alternate variant of overspray booth, in which a vertically disposed water cascade curtain, see at 140, is positioned rearwardly of the suspended/spray coated part, the curtain 140 forming a recessed vertical backdrop integrated into the forwardly facing booth interior. A bottom reservoir defining pan or tray 142 receives the continuous downward fluid flow from the curtain 140, such being collected into reservoir 144, a level of which can be maintained constant through a draining, filtering and combination recirculating cycle for preventing overflow and while providing for capturing of the overspray and associated solid particles for subsequent filtering for disposal or recycling.

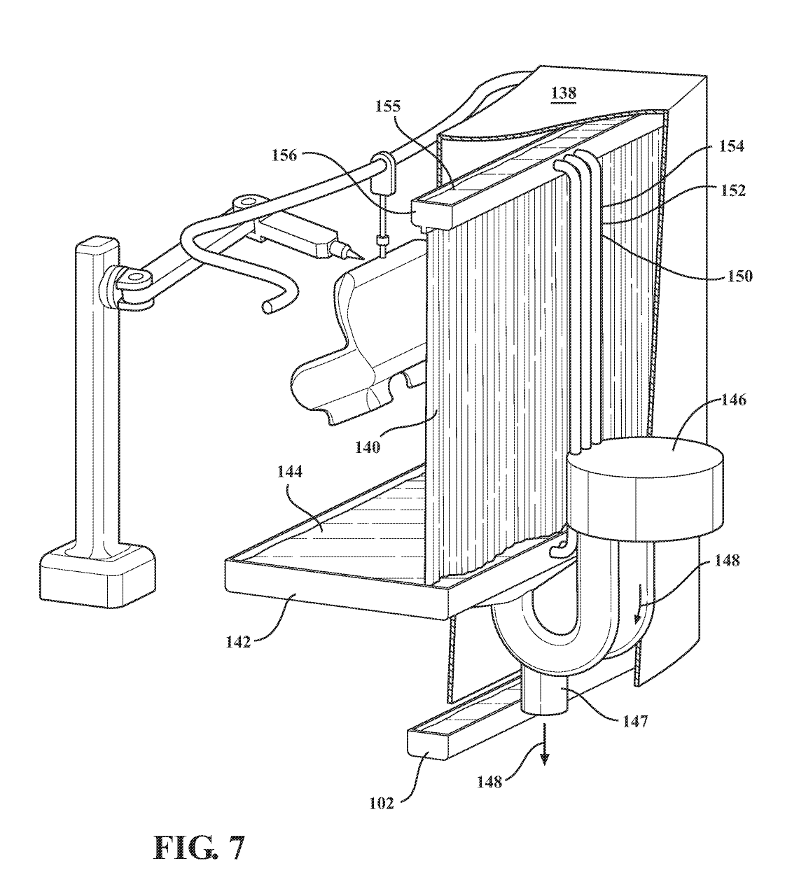

As further depicted in the rotated rear perspective and partial cutaway of FIG. 7, further illustrated is a combination pump and filtration system 146 incorporated into the fluid delivery architecture integrated into the vertical water curtain 140 and operating in combination with vacuuming of residual airborne particles as again provided by a separate blower 102 integrated into the overspray booth architecture. A lower outlet 147 provides for separation and removal of solid particulates (see further at 148) which are separated from the reservoir fluid (e.g. water or water based composition), the particulates capable of being recycled or disposed of as desired.

In order to maintain the continuous water curtain flow, an outlet/elevating side of the fluid pump 146 includes any plurality of upwardly extending fluid conduits (these depicted by conduits 150, 152 and 154) which upwardly feed fluid to an additional reservoir 155 established by an upper and horizontal length extending manifold 156, into which the conduits 150-154 empty. The forward and vertically extending collection face of the curtain 140 can include any fixed/rigid or flexible material including again a polymer or even a nylon, Teflon or other non-adhering consistency and which, in combination with the continuous downward water cascade along its forward face, causes any plastic overspray and particles to be captured and quickly descended into the lower reservoir, 144, following which the same is filtered, removed and/or recycled in the manner described.

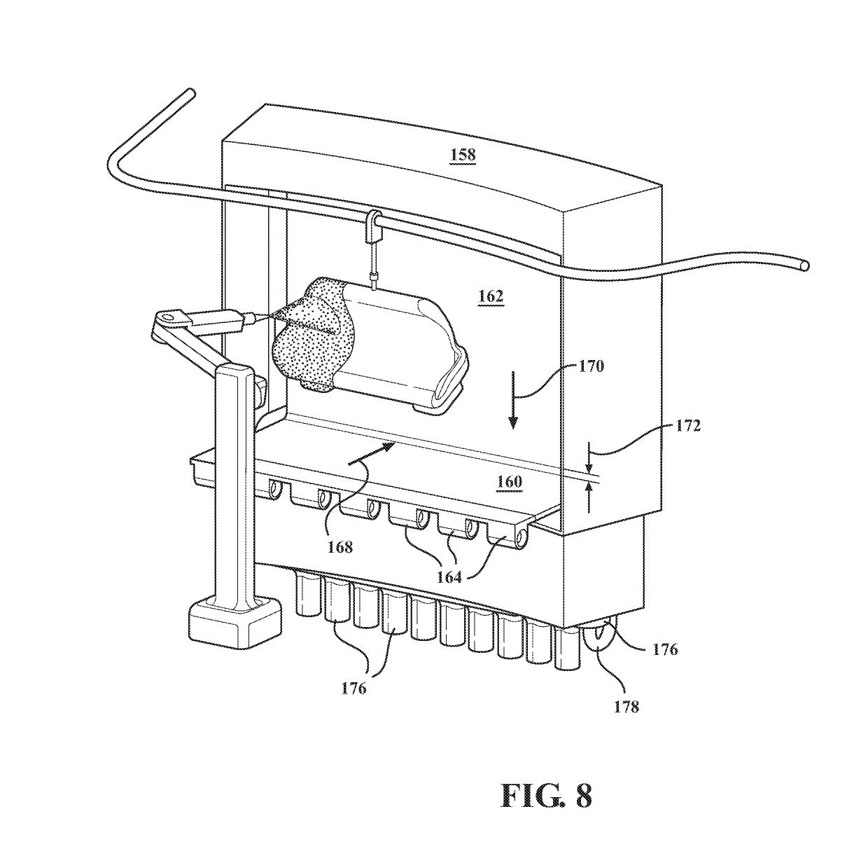

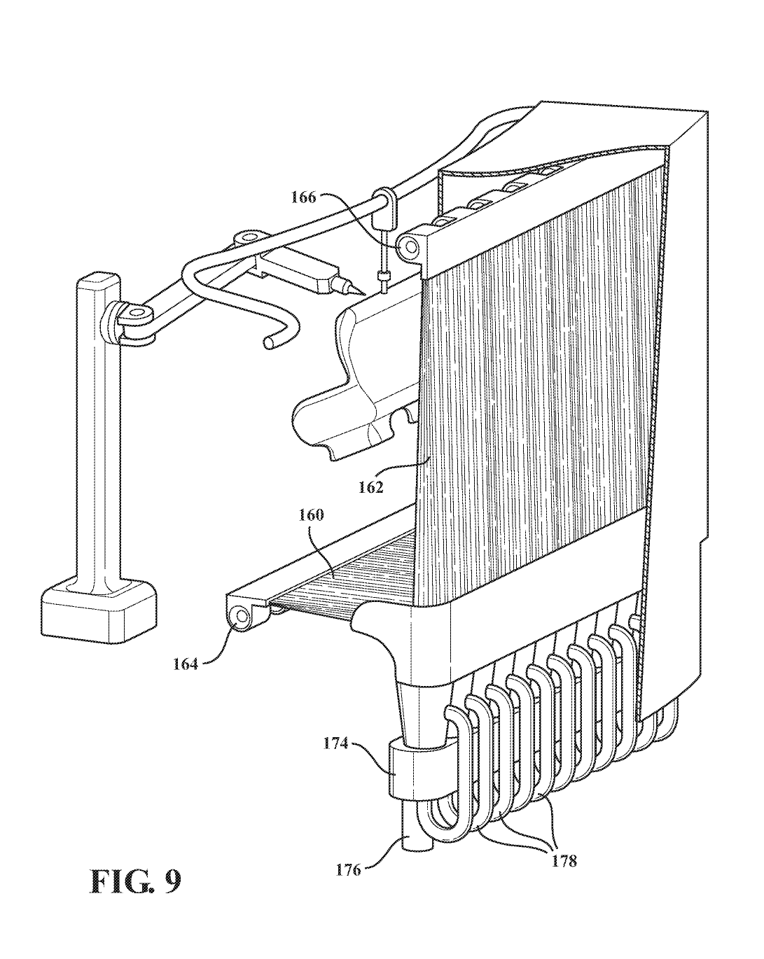

Proceeding to FIG. 8, is a perspective of a further alternate variant is shown at 158, similar in regards to that shown in FIGS. 3-5, and in which the forward facing recessed interior of the overspray housing is provided with a pair of horizontal 160 and vertical 162 belt driven and air/blower assisted curtains. The curtains 160 and 162 operate in combination with a pair of elongated blowers 164 and 166 (see further rotated cutaway of FIG. 9), the blowers being positioned at both forward most (again at 164) and upper edge most (again at 166) locations of the respective horizontal 160 and vertical 162 curtains, and to assist in capture and evacuation of overspray and associated particles resulting from the spray coating process.

Unlike the belt driven and liquid nitrogen chilled curtains of the previous embodiment, the air curtains can include any type of solid or weave material and it is further envisioned that the curtains can also be constructed as closed and traversable belts supported upon end rollers and traversable along inward 168 and downward 170 directions which are consistent with the travel of the overspray and associated particulates for collection within the interior of the booth 158. A width extending gap 172 (see again FIG. 8) can be provided between the curtains 160/162 at a merging location to further assist in removing the overspray and particulates.

As best shown in FIG. 9, a solid particulate retrieval and disposal/recycling manifold 174 extends along a bottom of the overspray housing interior and which includes any plurality of outfeed or collection locations, further at 176. Also depicted are a plurality of centrifugally airflow inducing lines, at 178, these being integrated into the blower architecture for promoting cyclonic action with centrifugally induced separation of the airborne particles associated with the captured overspray. In this fashion, the blower induced rearwardly 168 and downwardly 170 directed curtain surface proximate airstreams are converted into the cyclonic vacuum via the airflow inducing lines 178 and in order to successfully separate the overspray and associated vapors from the solids/particulates.

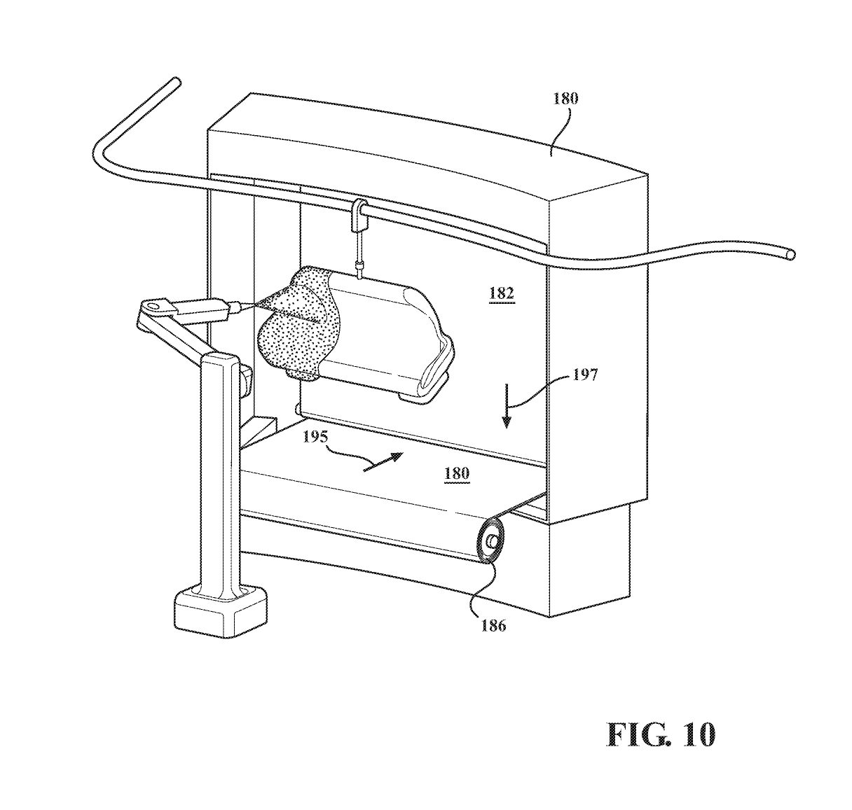

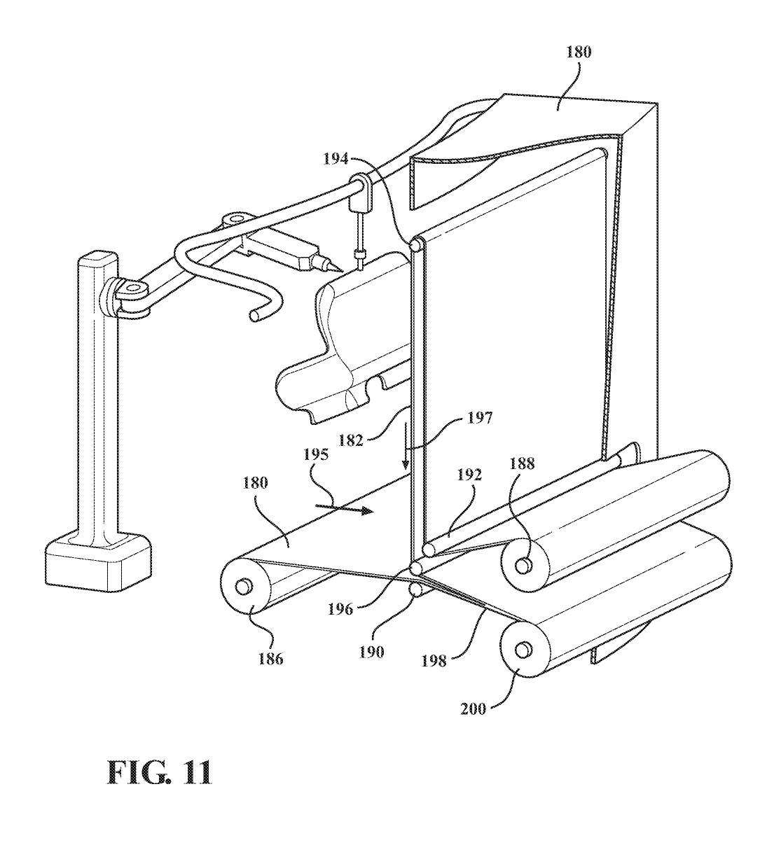

Finally, FIGS. 10 and 11 depicted a yet further variant 180 of overspray capture booth in which, as initially shown in FIG. 10, combines a pair of horizontal 182 and vertical 184 oriented advancing heavy duty paper curtains, these being built into the recess housing of the station for capturing the overspray and particles. As additionally shown in the rear rotated and perspective cutaway of FIG. 11, the horizontal advancing paper curtain 180 is fed from a forward and width secured feed roll 186 spaced forwardly from a lower recessed horizontal forward facing location of the capture booth. The vertical advancing paper curtain 184 is further fed from a rearwardly located feed roll 188, such as integrated into the booth or rearwardly therefrom.

As best shown in FIG. 11, a collection of redirecting rollers/axes are depicted at 190 for lower horizontal advancing paper curtain 180 and further by additional redirecting rollers at 192/194/196 in succession for vertical advancing paper curtain 182. The feed directions of the curtains are as shown at 195 for curtain 180 and at 197 for the vertically descending portion of the curtain 182 (this initially unwinding from roll 188 in an upward direction past redirecting roller 192 prior to be reverse directed downwardly by roller 194. In this fashion, the overspray resulting from coating of the part is captured upon the advancing surface areas of the paper curtains 180/182 and, upon these converging into a sandwiching contact after passing closely vertically spaced redirection roller bars or shafts 190/196 and partially offset roller shaft 192, the overspray and associated particulates are sandwiched between the sheets and subsequently collectively wound into a take up roll 200 for removal or recycling.

As depicted in the preceding embodiments, a suitable blower and/or vacuum retrieval architecture can be built into the overspray housing to assist the advancing paper curtains in the retrieval, removal or recycling of the plastic overspray and spray particulates or other contaminants. The ability to capture the overspray and particulates in sandwiched fashion between the opposing adhering surfaces of the paper curtains at the take up roll 200 further provides for ease of disposal or recycling.

Further, and as with any of the other embodiments described herein, the paper curtains can be operated/advanced continuously concurrent with the ongoing part spraying/advancing operation or can be iteratively advanced following each discrete spray coating operation. Additionally, and while referencing the various orientation of the various curtain or overspray reception surfaces as being vertical and horizontal, it is further understood and envisioned that such can be oriented in any angled or offset fashion consistent with the pattern of overspray and associated particulates.

Having described my invention, other and additional preferred embodiments will become apparent to those skilled in the art to which it pertains, and without deviating from the scope of the appended claims.

I claim:

1. An overspray capture booth for use in a part spray coating operation, comprising:
a structure integrating at least one reception surface for receiving an overspray of the spray coating operation; and
the overspray being communicated through a merging location established between the receiving surfaces and adapted to being removed or recycled.

2. The invention as described in claim 1, said at least one reception surface further comprising first and second oriented reception surfaces

3. The invention as described in claim 2, said reception surfaces further comprising a pair of horizontal and vertical closed loop belt curtains which are traversable supported about a pair of spaced apart rotating shafts.

4. The invention as described in claim 3, said closed loop belt curtains further comprising a passageway interior through which is communicated a chilling fluid for cooling said overspray reception surfaces.

5. The invention as described in claim 4, further comprising a pair of knife blades in contact with said reception surfaces.

6. The invention as described in claim 4, said closed loop belt curtains further comprising pluralities of offset ribs extending within said passageway interior from opposing inner surfaces to facilitate event chilling fluid dispersal.

7. The invention as described in claim 1, said at least one reception surface further comprising a waterfall curtain.

8. The invention as described in claim 7, a collection reservoir located beneath said water curtain.

9. The invention as described in claim 8, further comprising a water pump and filtration system integrated into said structure and pumping a steady fluid flow to a supply manifold located above said waterfall curtain. 10, The invention as described in claim 1, further comprising first and second blowers arrayed at respective forward and upper edges thereof of said first and second reception surfaces, an air curtain created by said blowers in a direction towards the overspray merging location.

11. The invention as described in claim 10, further comprising a bottom end collection location within said structure for removing solid particulates from the collected overspray.

12. The invention as described in claim 10, further comprising a plurality of centrifugal force inducing tubes integrated into said structure and converting said blower induced air curtain into a cyclonic vacuum through said merging location.

13. The invention as described in claim 2, said first and second reception surfaces further comprising traversing paper rolls for capturing the overspray therebetween at said merging location.

14. The invention as described in claim 13, said paper rolls further comprising first and second feed rolls and a common take up roll.

15. A spray coating assembly, comprising:
a closed loop overhead conveyor including an inlet location for acquiring, in succession, a plurality of inserts to be coated;
a main conveyor portion extending in substantially circular fashion and passing a plurality of stations for coating the inserts;
a plurality of individual branching locations extending from said main conveyor portion to each of said stations, said branching locations including each of inlet and exit locations for receiving selected inserts while permitting other inserts to pass along said main conveyor for delivery to succeeding stations; and
an outlet location for removing the coated inserts.

16. The invention as described in claim 15, each of said coating stations further comprising a spray applicating robot and an elevated and overspray capture structure, between which is positioned the overhead conveyed insert.

17. The invention as described in claim 16, further comprising a first conveyor for transporting the inserts to said conveyor inlet and a second conveyor for removing the coated inserts from said conveyor outlet.

18. The invention as described in claim 15, further comprising an inspection/repair station located at said conveyor inlet, a secondary operations (branding or labeling) station located at said outlet.

19. The invention as described in claim 15, further comprising a two part plasticized mixture delivered to a central location of said coating stations and subsequently distributed to said individual stations.

20. The invention as described in claim 15, said overhead conveyor further comprising a plurality of hangers extending downwardly therefrom, and on/off robot positioned in proximity to each of said inlet and outlet conveyor locations for both acquiring and removing the inserts.
